(19) United States
(12) Patent Application Publication
(10) Pub. No.: US 2025/0367851 A1
(43) Pub. Date: Dec. 4, 2025

(54) METHODS FOR PRODUCING A BIODEGRADABLE BINDING AGENT AND AN ARTICLE MADE FROM A BIO-COMPOSITE MATERIAL USING THEREOF

(71) Applicants: Ka Shuen Sze, Tracy, CA (US); Sina Shrike, Pune (IN)

(72) Inventors: Ka Shuen Sze, Tracy, CA (US); Sina Shrike, Pune (IN)

(21) Appl. No.: 19/308,071

(22) Filed: Aug. 22, 2025

Related U.S. Application Data
(63) Continuation-in-part of application No. PCT/US24/17569, filed on Feb. 27, 2024.
(60) Provisional application No. 63/448,693, filed on Feb. 28, 2023.

(51) Int. Cl. B27N 3/00; B27N 3/02

(52) U.S. Cl. CPC B27N 3/002; B27N 3/02

(57) ABSTRACT

A novel binding agent may be produced using a powder made by grinding a substance known as a spent mushroom substrate. Such a substance is a waste product of agricultural processes, and yet it contains a high quantity of mycelium, which in turn includes chitin, a natural polymer, that may be used as a key ingredient of the binding agent. Ganoderma lucidum fungi may be a preferred SMS because of its rich chitin content. The novel article, such as a mixed-density particle board, made from bio-composite materials, may be produced by a hot-pressing process using a mixture of the binding agent and a plurality of particles of at least a first natural substance, such as Coco coir to form the article.

### CROSS-REFERENCE DATA

The present patent application is a continuation-in-part of the co-pending PCT Patent Application No. PCT/US24/17569 filed on 27 Feb. 2024 with the same title, which in turn claims a priority date benefit from the U.S. Provisional Patent Application No. 63/448,693 filed on 28 Feb. 2023 and entitled “Bio-composite materials made from agricultural waste and methods of forming a particle board or panel using same,” both of these documents are incorporated herein by reference in their respective entireties.

### BACKGROUND

Without limiting the scope of the invention, its background is described in connection with a binding agent, methods for producing thereof, and methods of producing an article made from particles retained together by the binding agent. More particularly, the invention describes a binding agent produced from agricultural waste products, such as a spent mushroom substrate.

Generally speaking, agriculture involves a massive production of food. However, it is accompanied by the production of a variety of by-products that are not useful for direct human consumption, which is broadly referred to as agricultural waste. Disposal of agricultural waste is expensive and may have negative environmental consequences.

Repurposing agricultural waste and finding new uses thereof may generally fall into one of the following categories:
Biogas production: Agricultural waste such as cow dung and agricultural residues can be converted into biogas through anaerobic digestion. This process produces methane, which can be used as a source of renewable energy.
Composting: Agricultural waste can be composted to produce a nutrient-rich soil amendment. The compost can be used to improve soil fertility, retain moisture, and reduce the need for chemical fertilizers.
Livestock feed: Agricultural waste, such as crop residues and spoiled food, can be used as livestock feed. This helps to reduce the costs of feed production and provides an additional source of income for farmers.
Fuel production: Agricultural waste can be converted into biofuels such as bioethanol and biodiesel. This can help to reduce the dependency on non-renewable sources of energy and reduce greenhouse gas emissions.
Paper production: Agricultural waste, such as sugarcane bagasse, can be used to produce paper and other paper-based products. This helps to reduce the demand for wood, which is a finite resource.
Building materials: Agricultural waste such as rice husks, wheat straw, and corn stalks can be used to produce building materials such as insulation, flooring, and paneling.

Overall, the utilization of agricultural waste helps to reduce waste, conserve natural resources, and generate additional income for farmers.

A variety of useful articles may be made from wood chips, sawdust, wood shavings, and other wood particles, which otherwise may be treated as a common waste product. One non-limiting example of such an article is a particle board. A conventional particle board, also known as a chipboard, is a composite building material made from wood waste particles that are typically bonded together with a synthetic resin (used as a binding agent) under high heat and pressure. Urea formaldehyde resins are one example of a commonly used synthetic resin for these purposes. To produce a conventional particle board, the wood waste particles are first collected and dried to a consistent moisture content. The dried particles are then blended with a synthetic resin adhesive and shaped into a mat in a continuous press. The mat is then cut to size, dried, and hot-pressed again to finalize the bonding process. The resulting board is sanded and finished to provide a smooth surface for various applications, such as furniture, flooring, or cabinetry. The production process is generally cost-effective, as it utilizes waste materials that would otherwise go to waste. Still, the use of synthetic resins can result in the release of formaldehyde, which has been linked to health concerns and environmental pollution.

The use of synthetic binding agents in the production of particle boards presents several disadvantages, both environmental and health-related, alongside potential cost and performance concerns. Firstly, many synthetic binders are derived from petroleum-based products, which raises sustainability issues due to their non-renewable nature and the carbon footprint associated with their production and disposal. This contributes significantly to environmental pollution and exacerbates the depletion of finite natural resources.

Secondly, the emission of volatile organic compounds (VOCs) and formaldehyde-a common component in many synthetic adhesives-is a major health concern. These substances can off-gas from finished boards, compromising indoor air quality and posing risks such as respiratory problems, eye irritation, and other health issues to occupants of spaces furnished with particle board products. Additionally, the reliance on synthetic binders can lead to higher production costs, as the raw materials are subject to fluctuations in the global oil market, making the cost of particle board manufacturing more volatile. Finally, while synthetic binders often provide strong, durable bonds, their performance can be compromised under certain conditions, such as high humidity or exposure to water, leading to swelling, degradation of the board, and reduced lifespan of the final product. This limitation can restrict the use of particle boards to indoor applications or require additional treatments to enhance water resistance, further increasing costs and environmental impacts.

The need exists, therefore, for a greater utilization of natural binding agents, particularly those derived from agricultural waste products. Their use for particle board production is increasingly desirable for several reasons, emphasizing sustainability, ability to biodegrade in a friendly manner, health, and economic benefits. Firstly, these natural binders are renewable and abundantly available, often considered waste by-products from agricultural processes, thus providing an eco-friendly alternative to petroleum-based synthetic binders. By repurposing agricultural residues such as straw, husks, spent mushroom substrates, and shells, the production process significantly reduces environmental impact by minimizing waste and lowering the carbon footprint associated with manufacturing.

Furthermore, natural binders may generally emit lower levels of volatile organic compounds (VOCs) and formaldehyde compared to their synthetic counterparts, substantially improving indoor air quality and reducing health risks associated with long-term exposure to these chemicals. This aspect is particularly important in residential and commercial buildings where the safety and well-being of occupants are paramount.

Moreover, the use of agricultural waste as a raw material for binders can lead to cost reductions in the manufacturing process, as these materials are often inexpensive and locally available, reducing transportation costs and dependency on volatile oil markets.

Additionally, integrating natural binders into particle board production can enhance the material's biodegradability, making it more suitable for recycling and disposal, which aligns with the growing consumer demand for sustainable and eco-friendly building materials. This approach not only offers a sustainable solution to agricultural waste management but also contributes to the development of green technologies in the construction materials industry.

Spent Mushroom Substrate (SMS), also known as mushroom compost, is a common by-product of the mushroom cultivation industry, embodying a unique waste product within the agricultural sector. This material consists of the organic substrate left after mushrooms have been commercially harvested, typically including a mixture of materials like straw, peat, corn cobs, and other organic constituents that have been used as the growing medium. In terms of its chemical composition, it consists of a lignocellulosic material that contains a high percentage of cellulose, hemicellulose, and lignin, which are the main components of wood and other plant fibers. SMS also contains fungal mycelium and is rich in chitin.

The process of mushroom growth depletes the substrate of its initial nutrients, leaving behind a rich, decomposed organic matter that is no longer suitable for further mushroom cultivation but is still laden with beneficial properties. Despite being considered waste in the context of mushroom production, SMS holds substantial potential for reuse due to its high organic matter content, making it an excellent soil amendment for improving soil structure, moisture retention, and nutrient content. However, the direct application of SMS in agriculture must be managed carefully to avoid potential issues such as the introduction of unwanted salts or pathogens into the soil. The accumulation of SMS presents a disposal challenge for mushroom growers due to the substantial volume generated and the costs associated with its removal or treatment. Yet, its value as a sustainable resource for composting, land reclamation, and as a substrate in bioremediation practices is increasingly recognized, driving research and innovation in finding viable applications for this abundant agricultural by-product. The need, therefore, exists to find further uses of this abundant resource as part of a broader trend in the agricultural industry towards sustainability and the efficient utilization of waste products.

The concept of directly utilizing spent mushroom substrate (SMS) as a binding agent for particle board production is not a trivial undertaking and introduces a set of unique challenges, largely stemming from its inherent properties and the requirements for effective adhesive performance in board manufacturing. One primary difficulty is the variability in the composition of SMS, which depends on the specific materials used in mushroom cultivation and the conditions under which the mushrooms were grown. This variability can lead to inconsistencies in the performance of the SMS as a binder, affecting the strength, durability, and uniformity of the final particle boards. Achieving a consistent and reliable bonding quality may require extensive processing or the addition of other substances, potentially complicating the production process and increasing costs.

Furthermore, the organic nature of SMS means it is rich in nutrients and biological matter, which can be a double-edged sword. While beneficial for soil amendment, in the context of particle board production, this can lead to issues with biodegradation and mold growth, compromising the longevity and structural integrity of the boards. Ensuring the particle boards are resistant to such degradation may necessitate additional treatments or protective coatings, further complicating the manufacturing process and impacting the environmental benefits of using SMS as a binder.

Another challenge lies in the mechanical properties of SMS-based binders.

Traditional synthetic adhesives are engineered to provide strong, durable bonds that can withstand significant stress and environmental exposure. Replicating these properties with SMS, a material not inherently designed for adhesive purposes, can be difficult. This may affect the boards' performance in load-bearing applications or in environments with fluctuating humidity and temperature, limiting their practical uses.

Moreover, the process of preparing SMS to function effectively as a binding agent involves drying, grinding, and potentially chemically altering the substrate to enhance its adhesive properties. These processing steps require energy and resources, which could offset some of the environmental benefits of repurposing agricultural waste. Additionally, there may be regulatory and standardization hurdles to overcome, as introducing a new material into construction product manufacturing involves compliance with safety and performance standards, which can be a lengthy and costly process.

Overall, while the idea of using SMS as a binding agent in particle board production is attractive for its potential sustainability benefits, the practical difficulties in ensuring consistent quality, durability, and performance standards present significant hurdles. The need, therefore, exists for novel methods addressing these challenges and designed to consistently produce a binding agent that can be used for making articles containing wood particles.

### SUMMARY

Accordingly, it is an object of the present invention to overcome these and other drawbacks of the prior art by providing a novel binding agent produced using a natural substance.

It is another object of the present invention to provide a method for utilizing byproducts of agricultural production that may otherwise be discarded.

It is a further object of the present invention to provide a method for producing an article utilizing naturally occurring products.

It is yet a further object of the present invention to provide a novel article made using bio-composite materials.

The novel binding agent may be produced using a powder made by grinding a substance known as a spent mushroom substrate. Such a substance is a waste product of agricultural processes, and yet it contains a high quantity of mycelium, which in turn includes chitin, a natural polymer, that may be used as a key ingredient of the binding agent. Ganoderma lucidum fungi may be a preferred SMS because of its rich chitin content.

The novel article, such as a mixed-density particle board, made from bio-composite materials, may be produced by a hot-pressing process using a mixture of the binding agent and a plurality of particles of at least a first natural substance, such as Coco coir to form the article.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a table of typical characteristics of a spent mushroom substrate,

FIG. 2 is a table of chitin content in various types of spent mushroom substrate depending on the fungi type,

FIG. 3 is a photograph of a paste-like consistency of the hydrated spent mushroom substrate powder ready for use in producing the article of the invention,

FIG. 4 is a table summarizing experimental results of producing various articles using the method of the invention,

FIG. 5 is an exemplary tensile stress test of one of the articles produced using the method of the invention,

FIG. 6 is a top view of one exemplary particle board produced using the method of the invention,

FIG. 7 is a side view of the exemplary particle board of FIG. 6,

FIG. 8 is a top view of another exemplary particle board produced using the method of the invention,

FIG. 9 is a side view of the exemplary particle board of FIG. 8, and

FIG. 10 is an example of a laser etching produced using another exemplary particle board of the present invention.

### DETAILED DESCRIPTION OF PREFERRED EMBODIMENTS OF THE INVENTION

The following description sets forth various examples along with specific details to provide a thorough understanding of the claimed subject matter. It will be understood by those skilled in the art, however, that the claimed subject matter may be practiced without one or more of the specific details disclosed herein. Further, in some circumstances, well-known methods, procedures, systems, components, and/or circuits have not been described in detail in order to avoid unnecessarily obscuring the claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

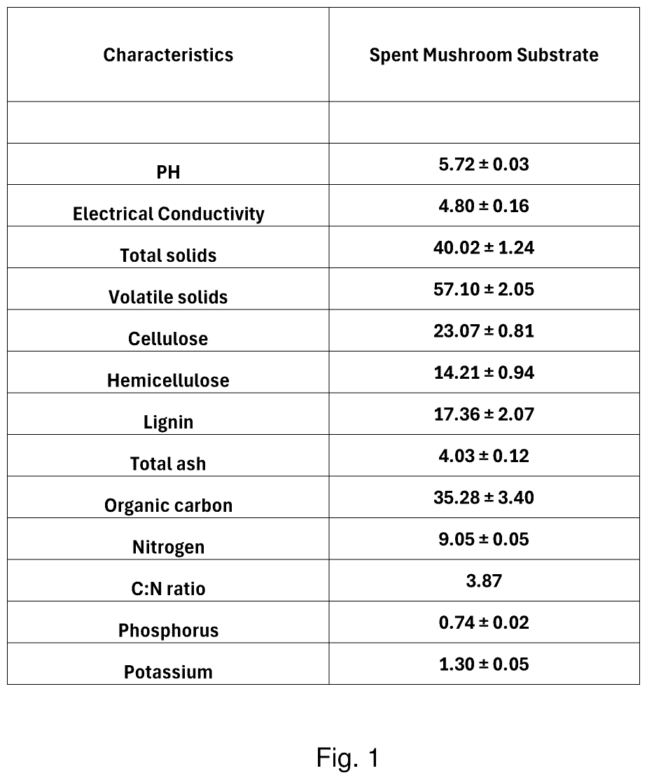

According to the present invention, the novel methods of producing a biodegradable binding agent employ spent mushroom substrate (SMS) as the core component thereof. It is strategically grounded in a number of key factors, namely that SMS is abundantly available as a byproduct of mushroom cultivation, and is chitin-rich. A list of typical SMS properties is found in FIG. 1.

Chitin, a complex polysaccharide, is a fundamental structural component found in the cell walls of fungal mycelium. Comprising repeating units of N-acetylglucosamine, chitin imparts strength and rigidity to the fungal cell walls, playing a pivotal role in maintaining their structural integrity. In addition to providing mechanical support, chitin serves as a versatile biomolecule with unique properties, such as biodegradability and biocompatibility. Beyond its structural significance, chitin possesses inherent qualities that make it an ideal candidate for various applications, including its potential role as a natural binding agent in material sciences.

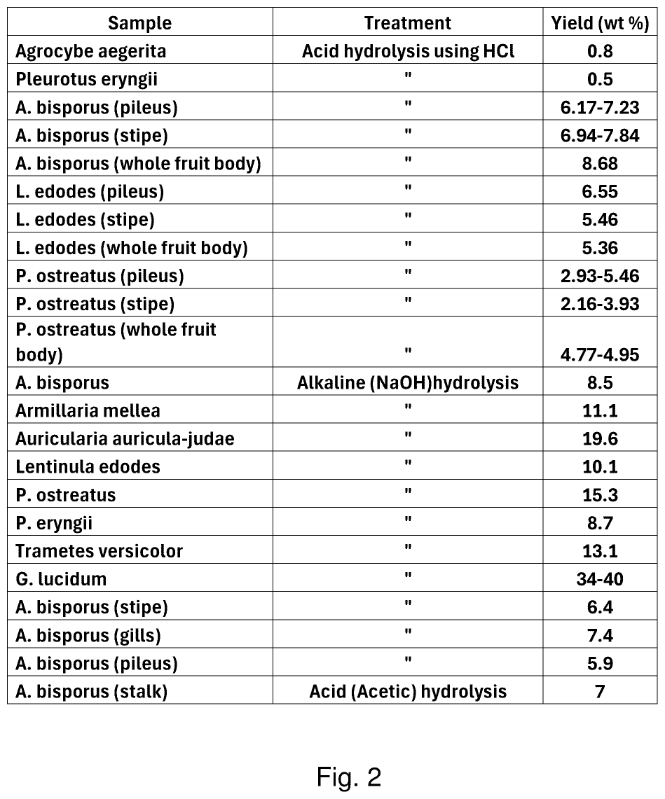

Chitin content can vary widely among different species of fungi. Some fungi are known to have higher chitin content than others. Chitin content can vary significantly depending on various factors such as the growth stage of the fungus, the part of the fungus analyzed, the method of analysis, and the environmental conditions in which the fungus was grown. Therefore, the chitin content reported in different studies may not be directly comparable, and a specific value for chitin content may not accurately reflect the true variability within a given fungal species. A list of exemplary chitin content in various mushroom species is found in FIG. 2. As can be seen from the table, some SMS are significantly richer in chitin than others. For example, Ganoderma lucidum fungi may have as much as 34-40 percent chitin by weight and, as such, may be a superior choice for the SMS as compared to other fungi species.

The novel method of producing a binding agent according to the invention may include the steps of:
(a) providing a spent mushroom substrate,
(b) drying the spent mushroom substrate to achieve a moisture content of 15 percent or less by weight. In further embodiments, the moisture content may be kept at 5 percent or less by weight,
(c) grinding the spent mushroom substrate into a ground spent mushroom substrate powder of particles sized 2 mm or less, such as in some embodiments, at 0.2 mm or less,
(d) prior to use as a binding agent, adding water to increase the moisture content to 55-65 percent by weight, and
(e) mixing the ground spent mushroom substrate powder and water to achieve a uniform paste-like consistency.

The step of drying the SMS may facilitate the storage of the final product prior to its use in producing the article of the invention. It may be advantageous to keep the moisture content at or below 15 percent by weight so as to avoid various degradation processes that may occur in the ground SMS powder at higher levels of the moisture content. In other embodiments, the moisture content may not exceed about 5 percent by weight. The step of grinding may be performed using any suitable machine to produce small, consistent SMS particles of the specified size, such as not to exceed 2 mm, or, in other embodiments, not to exceed 0.2 mm.

The step of adding water, such as distilled water, to increase the moisture content to a desired range of about 55 to 65 percent by weight may be conducted shortly before the use of the binding agent for making the article of the invention, as storage of the highly moist binding agent may cause its degradation.

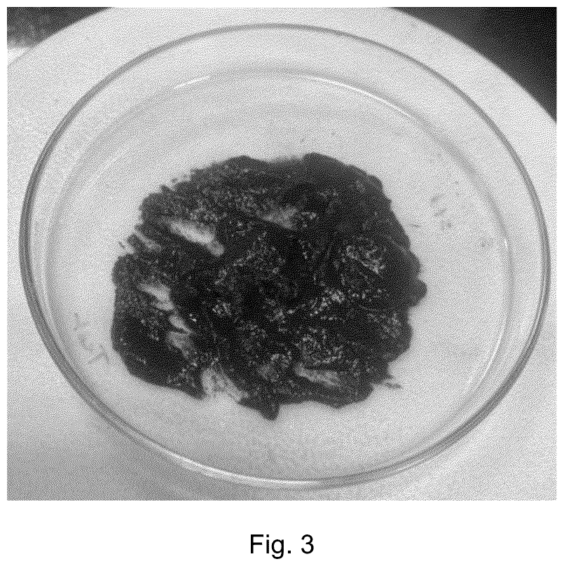

Once the water is added, a thorough mixing of the ground SMS powder with water may be implemented to produce a paste-like, consistent mixture, as seen in FIG. 3. Once the mixture is prepared, it may be used for the subsequent steps of the process of making the article of the invention.

The article of the invention may be made using a variety of wood particles and other natural fibers, as the invention is not limited in this regard. One useful example of such a substance is Coco coir. Coco coir is a natural material derived from the husks of coconuts. It is made by removing the fibrous material from the outer shell of the coconut and processing it into a variety of products. Coco coir is a sustainable and renewable resource, as coconut palms are abundant in many tropical regions, and the husks can be harvested without damaging the tree. Coir, like many other naturally derived fibers, consists of approximately 36-43% cellulose, 32.25% lignin, and 15.17% hemicellulose. Notably, coir stands out due to its lower degradation rate, attributed to its elevated lignin content, a key distinguishing factor from various other natural fibers. In comparison to alternative natural fibers, coir possesses several competitive advantages, including cost-effectiveness, lower density, increased elongation at break, and a reduced elastic modulus. These characteristics collectively underscore the significance of coir fibers as being advantageous for creating environmentally friendly particle boards, and in particular, mixed-density boards.

The key step in the article manufacturing process is hot pressing a mixture of the binding agent as described above mixed with or layered over a plurality of particles from first or further natural substances, such as Coco coir. In broad terms, the step of the novel process may include:
(a) providing a binding agent as described above,
(b) providing a plurality of particles of a first fiber-containing natural substance, such as Coco coir,
(c) arranging the binding agent and the plurality of particles of a first fiber-containing natural substance in layers or mixed together, wherein the binding agent comprising at least 20 percent by weight, at least 25 percent by weight, at least 30 percent by weight, at least 35 percent by weight, at least 40 percent by weight, at least 45 percent by weight, at least 50 percent by weight of the total arrangement,
(d) compressing the arrangement of step (c) at a pressure of at least 600 psi and at a temperature from about 150° C. to about 220° C. to form the article, and

(e) cooling the article for at least 15 minutes or to room temperature.

In further embodiments, the method for producing an article may further include a step of curing the arrangement of step (c) after step (d) by further compressing the article at a pressure below that of step (d) and/or heating to a temperature below that of step (d). Furthermore, a finishing treatment may be applied to one or all sides of the article, such as to improve decorative appeal, impregnate with insect repellent, or provide a desired coating.

In other embodiments, the method for producing an article may further comprise a step of adding a plurality of particles of a second fiber-containing natural substance in step (c). Examples of the second fiber-containing natural substance may include wood, cork, wine cork, wine wood, cellulose, and nano-cellulose.

Coco coir may be pretreated before undergoing the process described above with NaOH (sodium hydroxide). In one example, the raw coir may be shredded to produce particles and pieces having a length not exceeding about 150 mm. In other embodiments, the length of the Coco coir particles may be maintained between about 25 and about 50 mm. The plurality of such particles may then be treated with NaOH solution. The concentration of the NaOH solution may be from about 3 percent by weight to about 5 percent by weight. The duration of pretreatment may vary from about 2 hours to about 6 hours. The ratio of coir to NaOH solution may be above 1:1, such as 1:15. Once treated, the particles may be washed with distilled water and dried, such as using a heating oven, to remove most of the moisture therefrom and bring the moisture content to 5% by weight or below.

A number of different interactions may occur during the hot press process described above between the paste-like binding agent and the plurality of particles. These interactions are now described below in greater detail. Understanding the intricate mechanisms governing the interaction within the binding agent, comprised predominantly of chitin-rich spent mushroom substrate (SMS) and the particles of the first fiber-containing natural substance during the hot press process, is important in producing the article of the best possible quality.

Chitin Decomposition Temperature. Chitin, a pivotal component sourced from SMS, exhibits remarkable thermal stability, with decomposition occurring at temperatures above 220° C. For this reason, the heating of the article is limited to below 220° C.

Mechanical Interlocking. NaOH pretreatment may play a role in modifying the surface characteristics of coir fibers. It may roughen their surface, creating irregularities that enhance the mechanical interlocking potential during the hot press process. As the coir fibers soften under elevated temperature and pressure, they may conform to the irregularities presented by the chitin-rich SMS. This conformability may induce a mechanical interlock, bolstering physical adhesion and cohesion within the final bio-composite material of the article.

Chemical Interactions. The chemical interactions between NaOH-treated coir and chitin-rich spent mushroom substrate (SMS) in the binder may involve the introduced hydroxyl groups on the coir surface. These hydroxyl groups can participate in hydrogen bonding and other potential interactions with the functional groups present in chitin. furthermore, the amino and hydroxyl groups on the chitin molecules within SMS can form hydrogen bonds with the hydroxyl groups introduced on the coir surface through NaOH treatment. Hydrogen bonding is a type of intermolecular force where hydrogen atoms attached to electronegative atoms (such as oxygen) attract other electronegative atoms. This interaction contributes to the cohesion between chitin and coir, fostering stronger bonds.

Moisture Content. The optimal moisture content in SMS during heat pressing was identified as between about 55 percent by weight to about 65 percent by weight. This moisture level is found to enhance fiber/particle contact, promoting effective bond formation. Moisture content below 55% may weaken the bonding between SMS and the plurality of particles. Inadequate moisture may result in reduced interlinking between SMS and particles, diminishing the overall mechanical strength of the article.

At the same time, excessive moisture content during hot pressing may result in incomplete drying post-curing. This may lower mechanical strength and elevate humidity content, negatively impacting both the strength and insulation properties of the article.

Particle Size. Uniform particle sizes of coir and SMS may be advantageous to avoid the formation of voids in the particle boards, ensuring the highest possible mechanical strength and maximizing the interlink between the particles. Reduced particle size allows for a more even dispersion, creating an amorphous arrangement that enhances the mechanical strength of the final product.

Reduction in particle size improves fiber/particle contact that is crucial for effective bonding. Larger particle sizes result in imperfect interactions between fibers and particles, leading to weaker bonds. Moisture content in SMS serves as a form of reinforcement, automatically increasing fiber/particle contact.

Chitin Content in SMS. Higher chitin content in SMS correlates positively with the strength of the resulting boards. Chitin, being a natural polymer, enhances adhesive properties, contributing to robust intermolecular bonds during the hot press process. It strengthens the overall structure of the article, ensuring its durability and resilience.

Particle Volume (Coir:SMS Ratio 60:40). Higher fiber volume, specifically with a 60:40 ratio of particles to the SMS-based binding agent, leads to stronger particle boards and other articles. Coir particles/fibers contribute to the mechanical strength of the particle boards, and an elevated volume enhances their reinforcing effect.

### EXAMPLES AND EXPERIMENTS

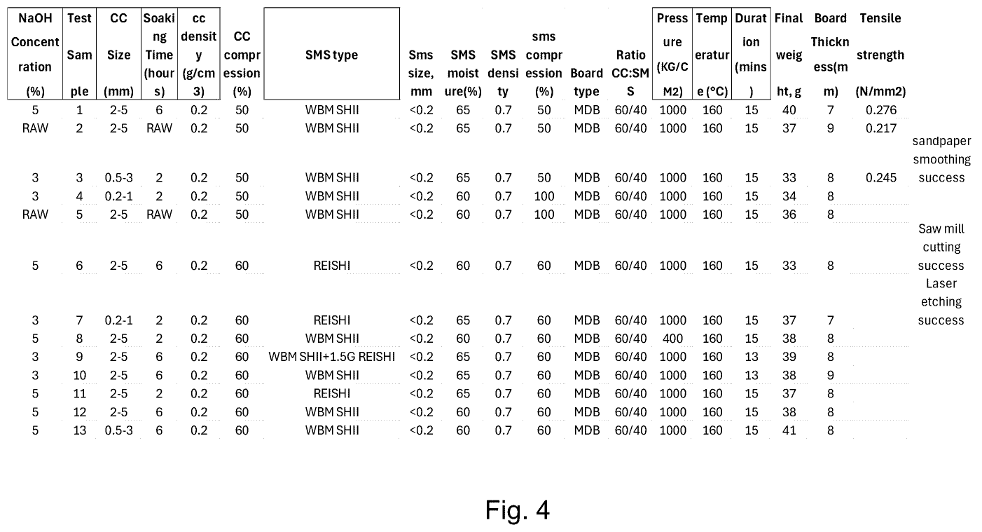

A variety of experimental mixed-density particle boards were produced and tested using the method described above. FIG. 4 shows a summary of these experiments, illustrating 13 examples of various particle boards. Abbreviations for SMS type in the table of FIG. 4 include WBM SHII=Wheat-Beech-Maple (substrate type) with fungi type Shiitake (Lentinula edodes); and Reishi=Ganoderma Lucidum. All experiments were done with SMS particle size at or below 0.2 mm, SMS density of 0.7, particle-to-bonding agent ratio of 60/40, and hot press temperature of 160 degrees C. These experiments allow the evaluation of various parameters on the quality of the produced particle boards.

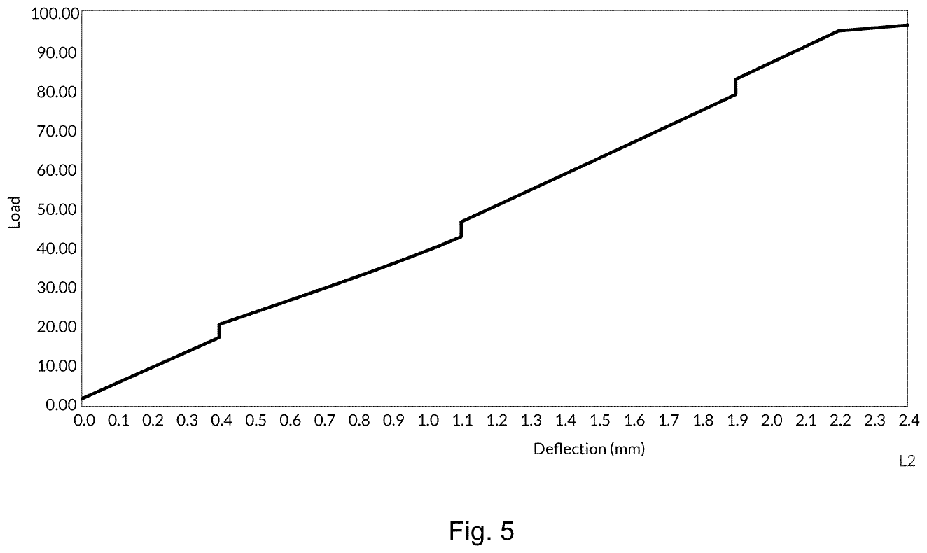

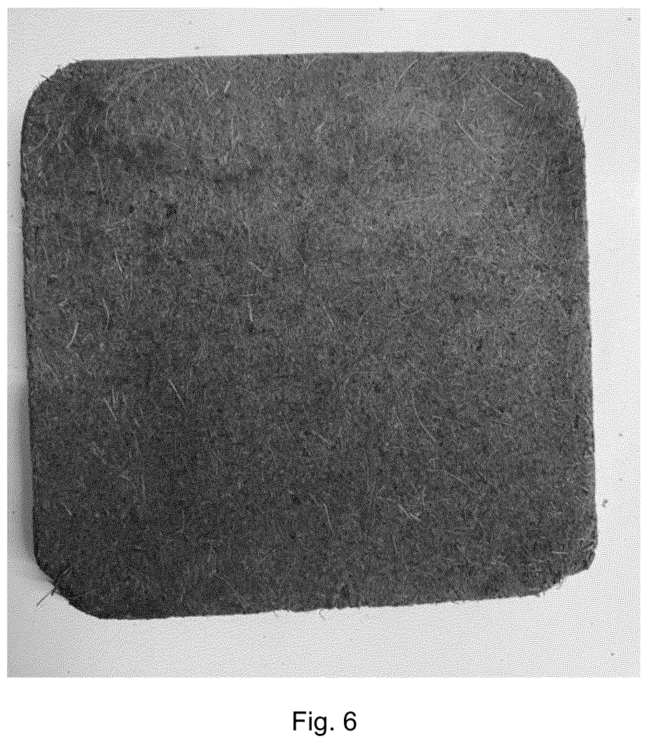

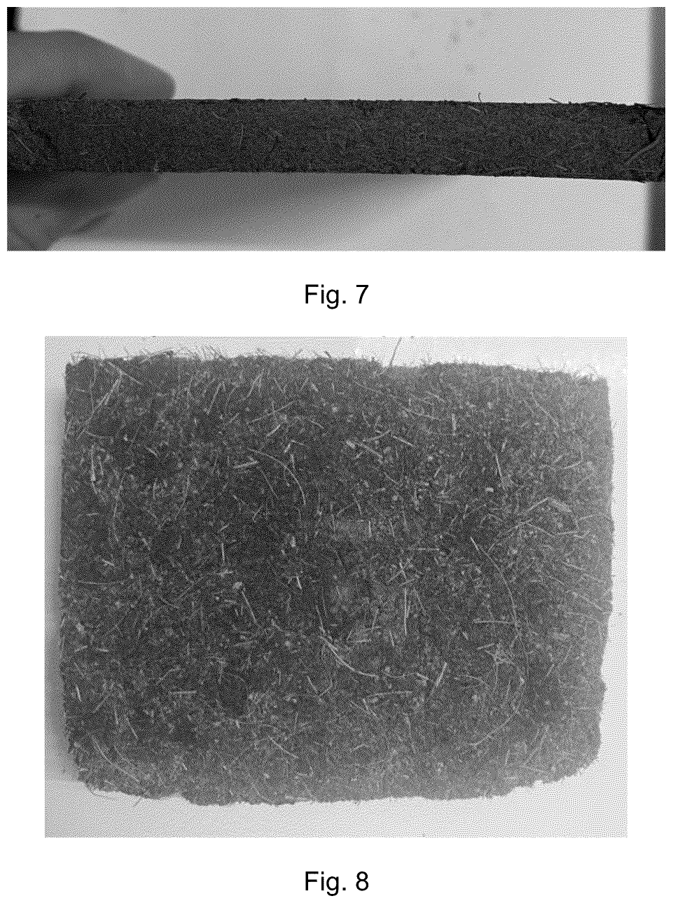

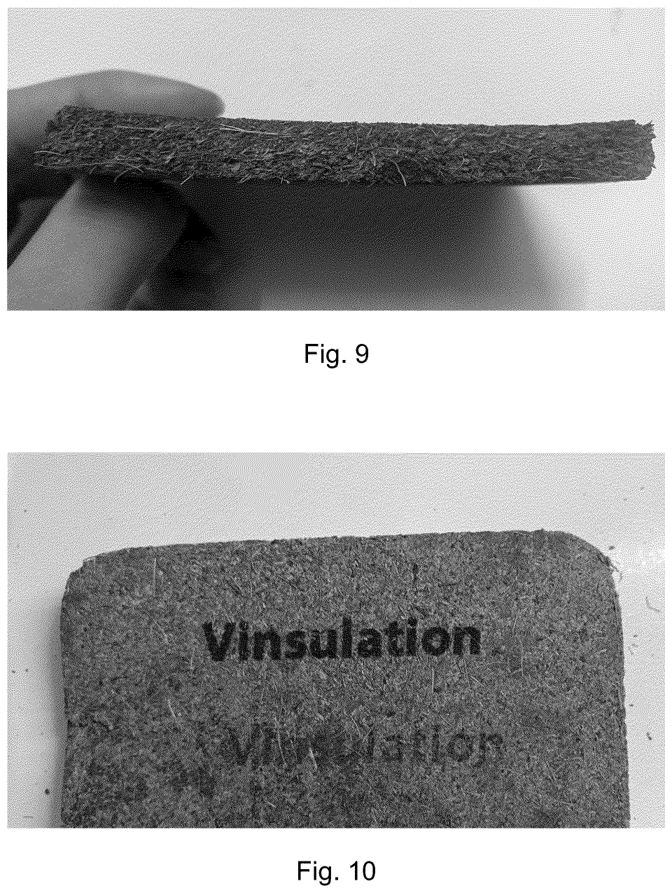

One exemplary tensile test recording is seen in FIG. 5. for board No. 2 in the chart, illustrating a relationship between Load (shown in Newtons) vs Deflection (shown in mm). FIGS. 6 and 7 show the top and side appearance of board No. 4. Board No. 3 allows for a successful sandpaper smoothing process, while board No. 6 allows for cutting using a sawmill (see the top and cut appearance in FIGS. 8 and 9). Board No. 7 allows for a successful laser etching process, as seen in FIG. 10.

In addition to the particle boards described above, the present invention has the potential to be used for producing a wide variety of other articles made using the bio-composite materials described above held together using the binding agent of the invention. These articles may be made for various industries and purposes.

One example of an article according to the invention is engineered wood flooring, which provides an economical and sustainable alternative to solid hardwood floors. These engineered planks are made by bonding layers of wood particles under high pressure and temperature, topped with a veneer of hardwood. This process not only recycles wood waste but also produces flooring that is more dimensionally stable and less prone to warping compared to traditional hardwood floors.

Wood particles and shavings are also fundamental in creating other composite materials, such as wood-plastic composites (WPCs). WPCs combine wood fibers with plastic, resulting in a material that has the workability of wood but the durability and resistance to rot and insects of plastic. These composites are used for outdoor decking, fencing, and furniture, offering a long-lasting and low-maintenance alternative to pure wood products.

In the realm of home décor and accessories, wood particles and shavings may be transformed into decorative items, such as picture frames, lamp bases, and wall art. These products often feature a unique texture and aesthetic that highlight the natural beauty of wood materials, while also contributing to waste reduction and sustainability.

Moreover, wood particles and fibers may be utilized in the production of insulation materials. By treating these particles and compressing them into panels or loose-fill insulation, manufacturers may create eco-friendly options for thermal and acoustic insulation in buildings. This not only helps in repurposing wood waste but also in reducing energy consumption in homes and offices.

Lastly, in the packaging industry, molded pulp products made from wood and other natural fibers offer a biodegradable and recyclable alternative to plastic and Styrofoam packaging. Items such as egg cartons, protective packaging for electronics, and disposable food containers are produced using this technology, significantly reducing the environmental impact of packaging waste.

These examples underscore the versatility and environmental benefits of the present invention and its potential in repurposing wood particles and shavings into valuable products, showcasing the innovative ways industries are moving towards sustainability by minimizing waste and maximizing resource use.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for producing a binding agent comprising the following steps:
(a) providing a spent mushroom substrate,
(b) drying the spent mushroom substrate to achieve a moisture content of 15 percent or less by weight,
(c) grinding the spent mushroom substrate into a ground spent mushroom substrate powder of particles sized 2 mm or less,
(d) prior to use as a binding agent, adding water to increase a moisture content to 55-65 percent by weight, and
(e) mixing the ground spent mushroom substrate powder and water to achieve a uniform paste-like consistency.

2. The method for producing a binding agent, as in claim 1, wherein step (b) of drying is done when the moisture content is at or below 5 percent by weight.

3. The method for producing a binding agent, as in claim 1, wherein in step (c) the particle size is maintained at 0.2 mm or less.

4. The method for producing a binding agent, as in claim 1, wherein step (d) of adding water is conducted using distilled water.

5. The method for producing a binding agent, as in claim 1, wherein the spent mushroom substrate in step (a) comprises Ganoderma lucidum fungi.

6. The method for producing a binding agent, as in claim 1, further comprising a step of storing the ground spent mushroom substrate powder of step (c) while maintaining moisture content of 15 percent or less by weight before initiating step (d).

7. A method of producing an article from a bio-composite material comprising the following steps:
(a) providing a binding agent of claim 1,
(b) providing a plurality of particles of a first fiber-containing natural substance,
(c) arranging the binding agent and the plurality of particles of a first fiber-containing natural substance in layers or mixed together, wherein the binding agent comprising at least 20 percent by weight of the total arrangement,
(d) compressing the arrangement of step (c) at a pressure of at least 600 psi and at a temperature from 150° C. to 220° C. to form the article, and
(e) cooling the article to room temperature.

8. The method for producing an article, as in claim 7, further comprising a step of curing the arrangement of step (c) after step (d) by further compressing the article at a pressure below that of step (d) and/or heating to a temperature below that of step (d).

9. The method to produce an article, as in claim 7, wherein the plurality of particles of the first fiber-containing natural substance in step (b) is dried prior to their use to produce the article to achieve a moisture content of 5 percent by weight or below.

10. The method to produce an article, as in claim 7, wherein the first fiber-containing natural substance is Coco coir.

11. The method to produce an article, as in claim 10, wherein the plurality of particles of the first fiber-containing natural substance is provided with individual particles not exceeding 150 mm in length.

12. The method to produce an article, as in claim 11, wherein the plurality of particles of the first fiber-containing natural substance is provided with individual particles not exceeding 50 mm in length.

13. The method to produce an article, as in claim 10, wherein in step (c), the binding agent comprises at least 40 percent by weight of the total arrangement.

14. The method for producing an article, as in claim 7, wherein the plurality of particles of the first fiber-containing natural substance are pretreated with sodium hydroxide, then washed and dried prior to their use to produce the article.

15. The method for producing an article, as in claim 7, further comprising a step of adding a plurality of particles of a second fiber-containing natural substance in step (c).

16. The method for producing an article, as in claim 15, wherein the second fiber-containing natural substance is selected from a group consisting of wood, cork, wine cork, wine wood, cellulose, and nano-cellulose.

17. The method for producing an article, as in claim 7, wherein the article is a particle board.

18. The method for producing an article, as in claim 17, wherein the article is a mixed density particle board.
